(19) United States
(12) Patent Application Publication
(10) Pub. No.: US 2013/0194327 A1
(43) Pub. Date: Aug. 1, 2013

(54) IMAGE PROCESSING METHOD AND IMAGE PROCESSING APPARATUS

(71) Applicant: CANON KABUSHIKI KAISHA, Tokyo (JP)

(72) Inventors: Katsushi Hara, Yokohama-shi (JP); Naoko Baba, Kawasaki-shi (JP); Satoshi Hayashi, Yokohama-shi (JP); Hajime Nagai, Kawasaki-shi (JP)

(73) Assignee: CANON KABUSHIKI KAISHA, Tokyo (JP)

(21) Appl. No.: 13/724,635

(22) Filed: Dec. 21, 2012

(30) Foreign Application Priority Data
Jan. 31, 2012 (JP) 2012-018358

(51) Int. Cl. B41J 2/195

(52) U.S. Cl. CPC B41J 2/195
USPC 347/7

(57) ABSTRACT

It is an objective of the present invention to provide an image processing method that can perform an accurate calibration corresponding to an ink receiving characteristic of a printing medium. The present invention obtains information regarding an ink amount that can be applied to a unit area of a printing medium. Then, the present invention determines, based on the information obtained, a combination of a plurality of ink application amounts corresponding to a plurality of first patches for adjusting ink application amounts corresponding to the respective gradation levels of an image to be printed on the printing medium.

### BACKGROUND OF THE INVENTION

1. Field of the Invention

The present invention relates to an image processing method and apparatus for performing a calibration to correct image data.

2. Description of the Related Art

In recent years, inkjet printing apparatuses have been required to always output colors in a stable manner. Thus, many inkjet printing apparatuses having a so-called color calibration function also have been known. The color method is a processing for correcting image data based on a color correction parameter generated for the purpose of suppressing the fluctuation of the colors of an image printed by a printing head so that an intended reference color (target color) can be always printed.

An inkjet printing apparatus having the color calibration function as described above is disclosed, for example, in Japanese Patent Laid-Open No. 2011-77844. According to this inkjet printing apparatus disclosed in Japanese Patent Laid-Open No. 2011-77844, a test pattern including a measurement color patch is outputted and measured on a printing medium to thereby obtain information regarding the colors of an image to be printed by a printing head. Then, based on the information for printing the reference color, a color correction parameter is generated. This color correction parameter is used to correct the image data to thereby suppress the color fluctuation.

Printing media having different ink receiving characteristics are used in an inkjet printing apparatus. For example, there are a printing medium including a printing ink receiving layer for preventing the bleeding of printing ink, a printing medium not including an ink receiving layer, or a printing medium of cloth material including a receiving layer for example. The printing media as described above can absorb different ink amounts or can allow different ink amounts to be fixed thereon (hereinafter referred to as a receivable ink amount).

However, the inkjet printing apparatus disclosed in the above Japanese Patent Laid-Open No. 2011-77844 does not consider the ink receiving characteristic of a printing medium. Thus, a disadvantage is caused in which some types of printing media cannot have a sufficient accuracy required for the color calibration.

### SUMMARY OF THE INVENTION

The present invention has been made in view of the above disadvantage of the prior art. It is an objective of the present invention to provide an inkjet printing apparatus and a calibration method by which an accurate calibration corresponding to the ink receiving characteristic of the printing medium can be performed.

In order to eliminate the above disadvantage, the present invention has a configuration according to any of the following sections.

Specifically, the first aspect of the present invention is an image processing method, comprising: an obtaining step of acquiring information regarding an ink amount that can be applied to a unit area of a printing medium; and a determination step of determining, based on the information obtained in the obtaining step, a combination of a plurality of ink application amounts corresponding to a plurality of first patches for adjusting ink application amounts corresponding to the respective gradation levels of an image to be printed on the printing medium.

The second aspect of the present invention is an image processing apparatus, comprising: an obtaining unit configured to acquire information regarding an ink amount that can be applied to a unit area of a printing medium; and a determination unit configured to determine, based on the information obtained in the obtaining step, a combination of a plurality of ink application amounts corresponding to a plurality of first patches for adjusting ink application amounts corresponding to the respective gradation levels of an image to be printed on the printing medium.

According to the present invention, the calibration adjustment pattern depending on the ink receiving characteristic of the printing medium is printed, thus providing an accurate calibration.

Further features of the present invention will become apparent from the following description of exemplary embodiments (with reference to the attached drawings).

### BRIEF DESCRIPTION OF THE DRAWINGS

FIG. 1 is a top view illustrating an inkjet printing apparatus in an embodiment of the present invention;

FIG. 2 is a block diagram illustrating the configuration of a control system in an embodiment of the present invention;

FIG. 3 is a flowchart illustrating the procedure of a color correction parameter generation processing;

FIG. 4 illustrates a test pattern for a color correction parameter generation processing;

FIG. 5 is a flowchart illustrating a printing processing using a color correction parameter;

FIG. 6 is a flowchart illustrating the determination of the receivable ink amount of the printing medium;

FIG. 7 illustrates the receivable ink amount determination pattern in the first embodiment;

FIG. 8A is a schematic view illustrating the configuration of the pattern A shown in FIG. 7;

FIG. 8B is a table illustrating the ink amounts printed on the pattern of the respective hues;

FIG. 9 is a table illustrating the total printing ink amounts of the patterns A to F shown in FIG. 7;

FIG. 10 is a table illustrating the ink application amounts of the test patterns in the first embodiment;

FIG. 11A is a graph illustrating the density d1 at the gradation value x1 of the expected density curve 1102 and the density d2 at the target density curve 1103;

FIG. 11B is a graph illustrating a correction curve for performing the color calibration generated based on the expected density curve 1102;

FIG. 11C is a graph illustrating the relation between the target density curve and the expected density curve by partially expanding the gradation;

FIG. 11D is an enlarged view of the interpolation region 1106 in FIG. 11C;

FIG. 12 is a flowchart illustrating the procedure of the processing for determining the receivable ink amount and the density characteristic of the printing medium in the second embodiment;

FIG. 13A illustrates the pattern 1300 for determining the receivable ink amount of the printing medium in the second embodiment;

FIG. 13B illustrates the configuration of the density determination pattern 1307;

FIG. 14 is a graph illustrating the density characteristic of the printing medium;

FIG. 15 is a table illustrating the ink application amounts of the test pattern in the second embodiment;

FIG. 16A is a graph illustrating the relation between the target density and the measured density in the second embodiment;

FIG. 16B is a graph illustrating the enlarged interpolation region 1602 in FIG. 16A;

FIG. 17 is a table illustrating the difference in the test pattern between light ink and dark ink;

FIG. 18 is a table illustrating the ink application amounts of the test pattern in a comparison example;

FIG. 19A is a table illustrating the relation between the target density and the measured density in the comparison example; and

FIG. 19B is a graph illustrating the enlarged interpolation region 1902 in FIG. 19A.

### DESCRIPTION OF THE EMBODIMENTS

### First Embodiment

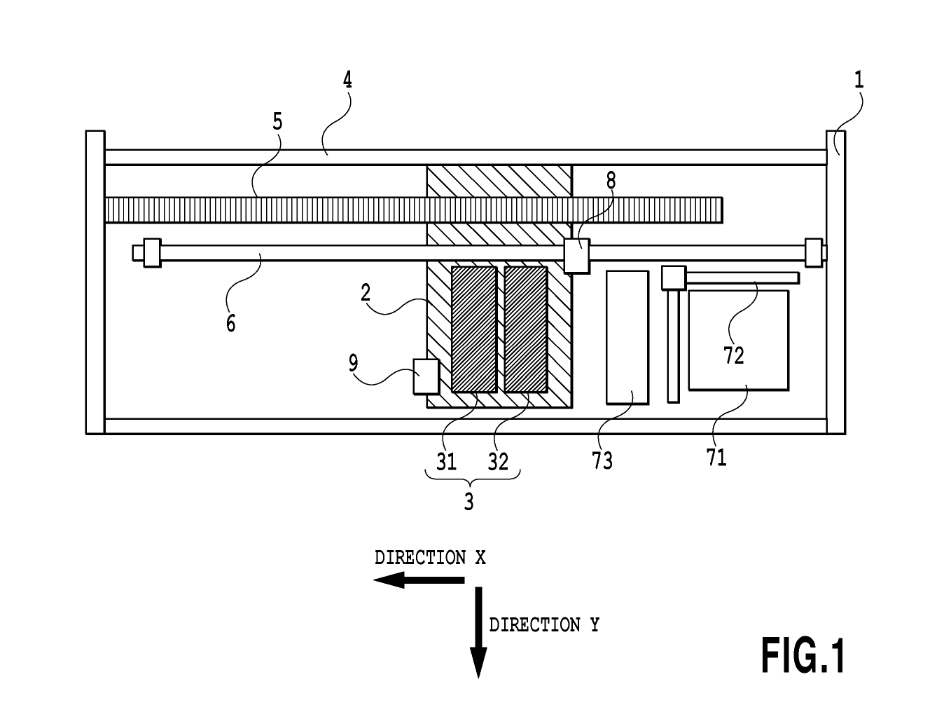

First, the first embodiment of the present invention will be described with reference to FIG. 1 to FIG. 11D. FIG. 1 is a top view illustrating an inkjet printing apparatus in the first embodiment of the present invention. In FIG. 1, the reference numeral 1 denotes a printing apparatus body including various mechanism sections including a transport system unit (not shown) for transporting a printing paper (printing medium). This printing apparatus body 1 and a control system (which will be described later) provided in the printing apparatus body 1 constitute the inkjet printing apparatus (hereinafter simply referred to as a printing apparatus). The printing apparatus shown in this embodiment is a so-called serial printing apparatus that performs a printing operation by allowing the transport system unit to intermittently transport the printing medium in the direction Y (sub scanning direction) while allowing the printing heads 31 and 32 to move in the direction X orthogonal to the direction Y (main scanning direction). The printing apparatus body 1 shown in FIG. 1 has an increased size in the direction X so that a relatively-large printing medium (e.g., AO size) can be printed.

In FIG. 1, the reference 2 denotes a carriage storing therein the printing heads 31 and 32. This carriage 2 is movably supported by a guide axis 4 provided along the direction X and is fixed to an endless belt 5 that moves in a direction substantially parallel to the guide axis 4. The endless belt 5 is reciprocated by the driving force from a carriage motor (CR motor) to thereby reciprocate the carriage 2 in the direction X (main scanning direction). The carriage 2 also includes a carriage raising and lowering mechanism 8 for raising and lowering the carriage 2 and an optical reading unit (density sensor) 9 for detecting the printing medium or the density of the image. In this embodiment, the density sensor 9 is composed of a reflective optical sensor including a light emitting section and a light-receiving section.

The printing apparatus body 1 also includes a recovery processing apparatus for maintaining a favorable ink ejection performance of ink outputted through the respective ejection openings of the printing heads 31 and 32. This recovery processing apparatus is retained at a predetermined position of the printing apparatus body 1 and includes, for example: a suction recovery mechanism 71; a wiping recovery mechanism 72; and a preliminary ejection ink receiving box 73 for example.

The position of the carriage 2 is detected by allowing a main control section 200 (which will be described later) to count pulse signals outputted from the encoder sensor 215 according to the travel of the carriage 2. Specifically, the encoder sensor 215 outputs a pulse signal to the main control section 200 by detecting detection sections formed at a fixed interval thereamong on the encoder film 6 provided in the main scanning direction. The main control section 200 counts the pulse signals to thereby detect the position of the carriage 2. The carriage 2 is moved to the home position or other positions based on the signal from the encoder sensor 215.

One printing head 31 provided in the carriage 2 is composed of a plurality of printing chips through which inks of a plurality of colors can be ejected. In this embodiment, the printing head 31 is composed of printing chips corresponding to photo cyan ink, cyan ink, mat black ink, yellow ink, magenta ink, and photo magenta ink, respectively. The other printing head 32 is similarly composed of six printing chips respectively corresponding to red ink, green ink, blue ink, photo grey ink, grey ink, and photo black ink.

Each printing chip includes 1280 ejection openings arranged in a staggered manner at a concentration of 1200 dpi (dot/inch). By providing two such staggered arrangements in each of the printing chips, the total of 2560 ejection openings are arranged. The entire printing apparatus is configured so that the total of 28160 ejection openings are arranged in 12 lines in the main scanning direction at a concentration of 1200 dpi in the sub scanning direction. By ejecting the above-described inks of 12 colors through these ejection openings, a color image is printed on a printing medium.

The printing heads 31 and 32 have an energy generating element for generating the ejection energy for ejecting ink through an ejection opening (hereinafter also referred to as a printing element). In this embodiment, this energy generating element is an electric thermal conversion structure that locally heats ink to cause film boiling so that the pressure by the boiling is used to eject ink. However, the present invention is not limited to this. An electric mechanical conversion element also may be used.

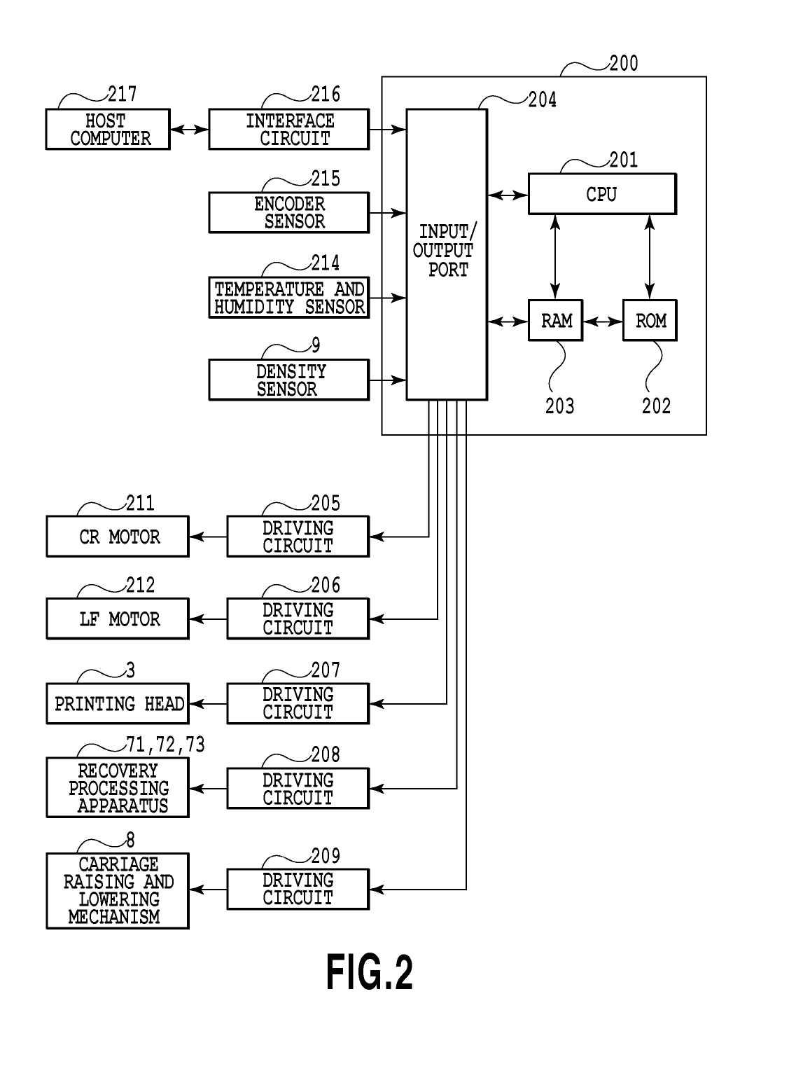

FIG. 2 is a block diagram illustrating the configuration of a control system (control unit) provided in the printing apparatus body 1 of the inkjet printing apparatus in this embodiment.

In FIG. 2, the reference numeral 200 denotes a main control section that is connected via an interface circuit 216 to a host computer 217. This main control section 200 includes, for example: a CPU 201 that performs a processing operation such as calculation, control, determination, selection and setting; a ROM 202 that stores therein control programs for example to be executed by this CPU 201; a RAM 203 that temporarily stored data; and an input/output port 204. The RAM 203 is used as a buffer for storing binary printing data showing the ejection or no ejection of ink and a work area for the processing by the CPU 201 for example. The CPU 201 provides a function as a calibration adjustment pattern selecting unit and a function as a correction table generation unit in the present invention. The RAM 203 provides a function as an adjustment pattern storage unit and a table storage unit for storing a correction table (which will be described later).

The input/output port 204 is connected to: a driving circuit 205 of the carriage motor (CR motor) 211 in the transport unit; a driving circuit 206 for driving the transport motor (LF motor) 212; and a driving circuit 207 for driving the printing heads 31 and 32. The input/output port 204 is also connected to the respective driving circuits 208 and 209 for the recovery processing apparatuses 71, 72, and 73 as well as the carriage raising and lowering mechanism 10. The input/output port 204 is also connected to a temperature and humidity sensor (detection unit) 214 for detecting the temperature and humidity of the surrounding environment and the encoder sensor 215 fixed to the carriage 2 for example. The image printing unit and various pattern printing unit (which will be described later) are configured by the main control section 200 constituting the control unit provided in the printing apparatus body 1 and the printing heads 31 and 32 and carriage 2 controlled by the main control section 200 via the driving circuit for example. These unit function as an adjustment pattern printing unit for printing a calibration adjustment pattern (which will be described later), a receivable ink amount determination pattern printing unit, and a density characteristic determination pattern printing unit for example in the first embodiment and the second embodiment described below.

Next, the following section will describe the printing operation carried out by the inkjet printing apparatus having the configuration as described above.

When printing data from the host computer 217 is received via the interface, the printing data is developed in the RAM 203 as a buffer. Then, when a printing operation is instructed, the carriage 2 uses a carriage motor (not shown) and the endless belt 5 to reciprocate the printing heads 31 and 32 provided in the carriage 2 in a direction parallel to the guide axis 4. At the same time, ink is ejected through the nozzles in the printing heads 31 and 32 to thereby form an image having a size corresponding to the nozzle width. Next, a printing medium is transported by a fixed amount in the sub scanning direction. Thus, an image is formed by the repetition of the printing operation by the printing heads 31 and 32 and the operation to transport the printing medium in the sub scanning direction.

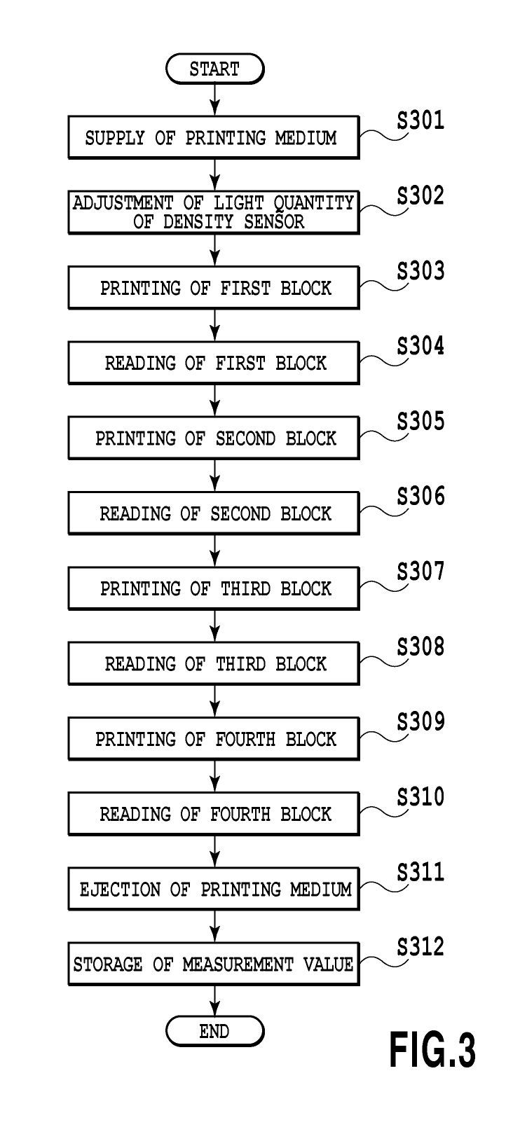

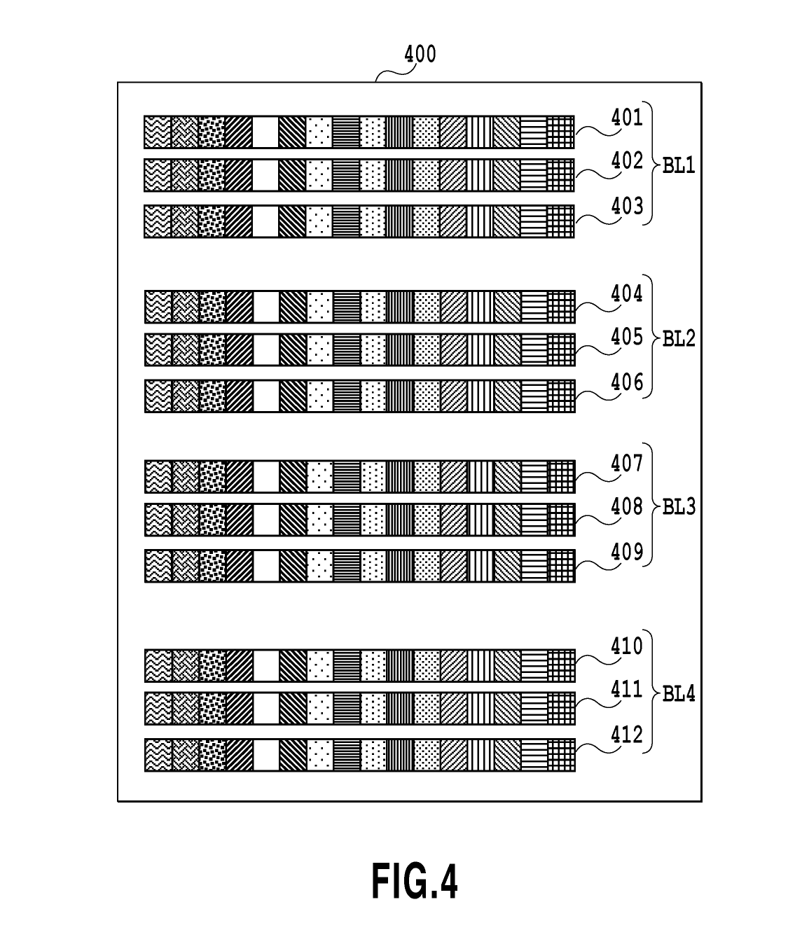

FIG. 3 is a flowchart illustrating the procedure of the color correction parameter generation processing performed in this embodiment having a so-called color calibration function for correcting color input image data depending on the ink ejection characteristic of the printing head for example. The color calibration means a processing for adjusting an ink amount applied to a unit area of a print medium in which image should be printed. Firstly, Step S301 sets a printing medium to be subjected to the color correction parameter generation processing. Step S302 performs the light quantity adjustment of the light emitting section of the density sensor 9 for measuring the test pattern (calibration adjustment pattern) 400 shown in FIG. 4. Step S303 prints the first block of the test pattern 400.

FIG. 4 shows the configuration of the test pattern 400 used for the color correction parameter generation processing. The first block BL1 printed in Step S303 is composed of three patches for three colors of a mat black ink patch 401, a red ink patch 402, and a grey ink patch 403. Each color is composed of 16 patches (16 first patches) of 16 gradations. After the first block BL1 is printed, Step S304 allows the density sensor 9 to measure the densities of the patches of the first block BL1 of the test pattern.

Step S305 prints the second block BL2 (see FIG. 4) of the color calibration test pattern. The second block BL2 is composed of three patches for three colors of a yellow ink patch 404, a photo grey ink patch 405, and a photo black ink patch 406. Each color is composed of 16 patches of 16 gradations. After the second block BL2 is printed, Step S306 allows the density sensor 9 to measure the densities of the patches of the second block BL2.

Step S307 prints the third block BL3 (see FIG. 4) of the test pattern. The third block BL3 is composed of three patches for three colors of a photo magenta ink patch 407, a magenta ink patch 408, and a blue ink patch 409. Each color is composed of 16 patches of 16 gradations. After the third block BL3 is printed, Step S308 allows the density sensor 9 to measure the densities of the patches of the third block BL3.

Step S309 prints the fourth block BL4 (see FIG. 4) of the test pattern. The fourth block BL4 is composed of three patches for three colors of a photo cyan ink patch 410, a cyan ink patch 411, and a green ink patch 412. Each color is composed of 16 patches of 16 gradations. After the fourth block BL4 is printed, Step S310 allows the density sensor 9 to measure the densities of the respective patches of the fourth block BL4. In this embodiment, a density value is obtained from the density sensor 9 as a pattern measurement value. However, another embodiment is also possible in which a color measurement device that can obtain a coloring value for example is used to obtain a CMYK value, a L*a*b* value, an XYZ value, and an RGB value of the pattern.

Through Steps S301 to S310 as described above, the printing and the measurement of the test pattern required for the color correction parameter generation processing are completed. Thus, Step S311 ejects the printing medium. Finally, Step S312 allows the measurement result showing the measurement values (density values) of the respective patches to be set in the RAM 203 of the main control section 200, thereby completing the color measurement processing.

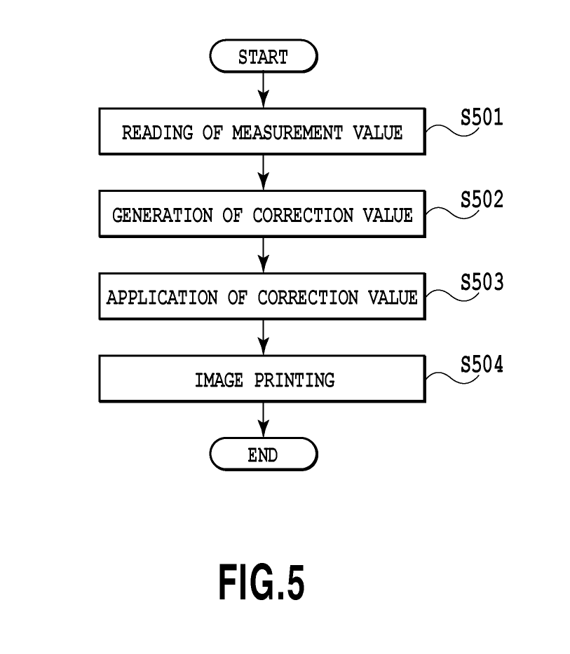

FIG. 5 is a flowchart illustrating the processing to use the color correction parameter obtained through the above-described processing to perform the density of the input image data and the image printing. First, Step S501 reads the measurement value (density value) stored in the color measurement processing of FIG. 3. Next, Step S502 generates a color correction parameter for correcting the input image data. In this embodiment, this color correction parameter is generated by the embodiment of the color correction table. Step S503 applies the color correction parameter to the inputted image data to correct the data. By this correction, the input image data can be corrected so that the reference color having the color target value can be outputted. Step S504 prints the corrected image data. By applying, as required, the color correction parameter as described above, a stable image free from color fluctuation can be always outputted.

Next, the following section will describe in detail a processing for determining the calibration adjustment patterns corresponding to the respective printing media having various receivable ink amounts as a characteristic of the first embodiment. As described above, the amount of ink that can be absorbed in a unit area is different depending on the type of the printing medium. Thus, it is required to obtain, without causing a defective image such as ink spill or bleeding, the maximum ink application amount having a high image density (receivable ink amount) for each printing medium. In order to perform an accurate color calibration with a limited number of patches, it is desirable that the ink application amount to the respective patches in the calibration adjustment pattern is determined based on the receivable ink amount. In this embodiment, the receivable ink amount determination pattern is recorded to determine the receivable ink amount to thereby determine the gradation levels of the respective patches of the calibration adjustment pattern, thereby determining the application amount of the respective patch inks.

In the first embodiment, as a receivable ink amount determination pattern for determining the calibration adjustment pattern, depending on the receivable ink amount as one of the characteristics of the printing medium, a plurality of test patterns (second patches) having different combinations of ink application amounts are prepared in advance. Then, optimal test patterns for the respective types of printing media are selected by a user. The RAM 203 stores therein the data for a plurality of calibration adjustment patterns corresponding to the respective receivable ink amounts. Then, the calibration adjustment pattern corresponding to the receivable ink amount of a test pattern selected by the user from among the plurality of stored calibration adjustment patterns is determined as an optimal calibration adjustment pattern for this printing medium.

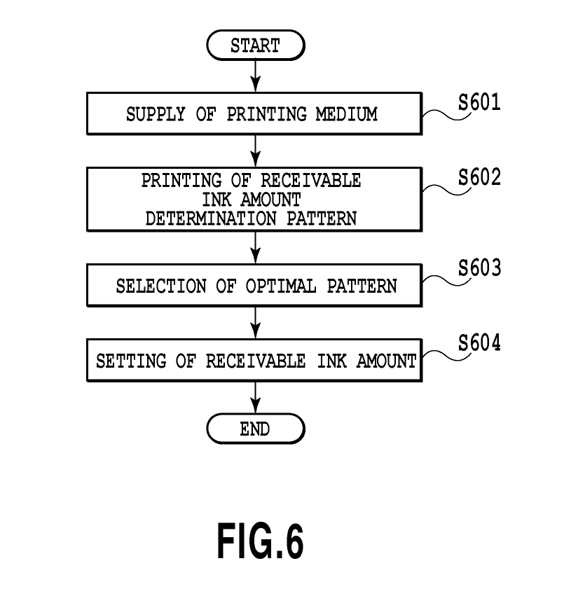

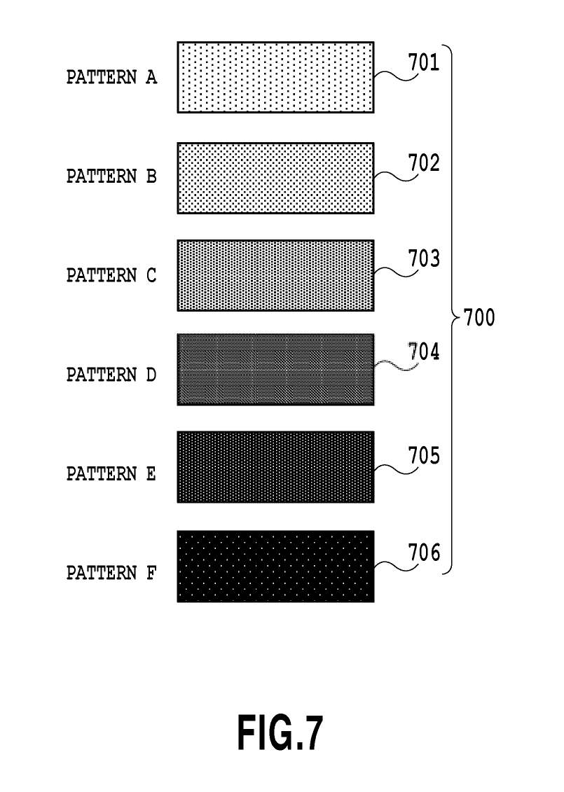

FIG. 6 is a flowchart of the procedure of the processing for determining the receivable ink amount showing an ink receiving characteristic of a printing medium. First, Step S601 sets a printing medium in the inkjet printing apparatus. Step S602 prints, on the printing medium, a pattern (determination pattern) as shown in FIG. 7 for determining the receivable ink amount of the printing medium. The determination pattern of the receivable ink amount is a pattern in order to allow the user to select an appropriate receivable ink amount.

FIG. 7 shows the receivable ink amount determination pattern 700 (also called as a determination pattern) of this embodiment. The shown determination pattern 700 includes: a pattern A (701); a pattern B (702); a pattern C (703); a pattern D (704); a pattern E (705); and a pattern F (706). These six patterns (six second patches) are configured to have such ink amounts given to a unit area of the printing medium that are changed in a stepwise manner. The ink amounts given to a unit area of the printing medium are a causing factor having a significant influence on the image density, the color reproduction range, and the image quality such as bleeding on the printing medium. The ink amounts given to a unit area of the printing medium are a physical amount corresponding to the “receivable ink amount” described herein.

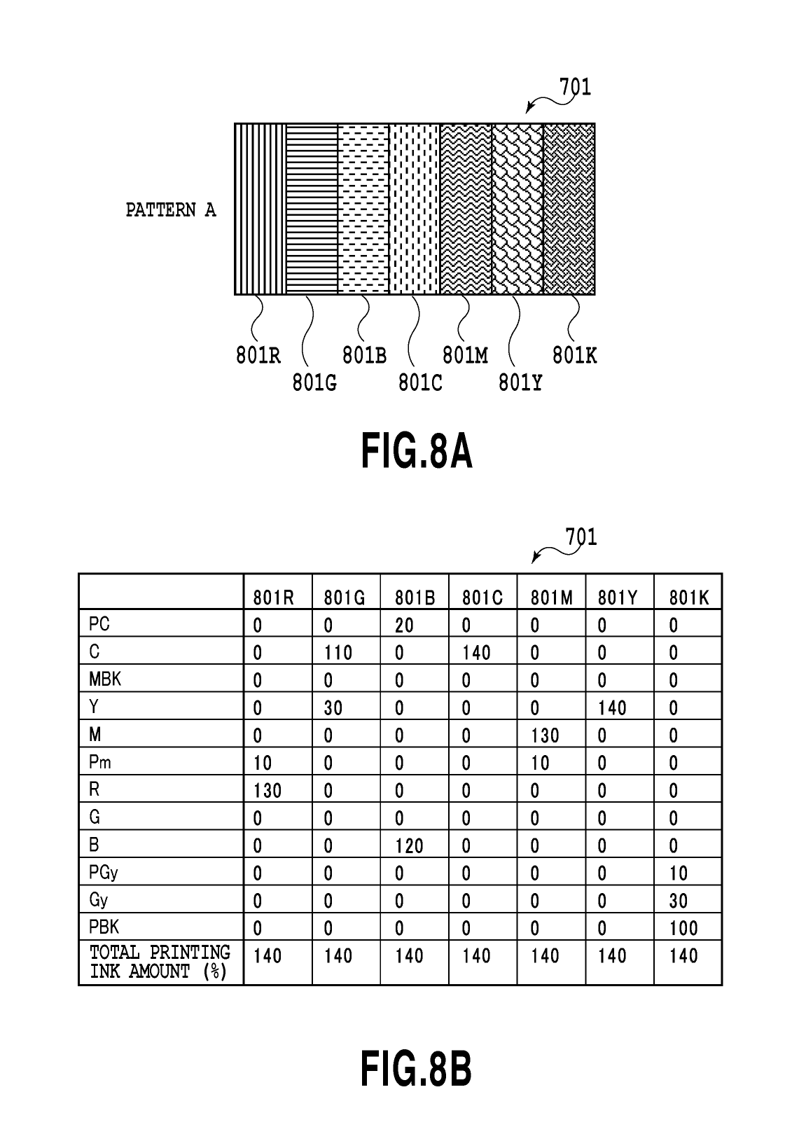

FIG. 8A is a schematic view illustrating the configurations of the respective patterns constituting the receivable ink amount determination pattern 700 shown in FIG. 7. The pattern A shown in FIG. 8A is composed of the seven patterns 801R, 801G, 801B, 801C, 801M, 801Y, and 801K. The seven patterns 801R, 801G, 801B, 801C, 801M, 801Y, and 801K represent red, green, blue, cyan, magenta, yellow, and black hues, respectively.

FIG. 8B is a table illustrating the ink amounts (ink application amounts) given to the respective hue patterns. The inkjet printing apparatus of this embodiment includes therein the inks of 12 colors. Thus, the table describes the ink application amount (%) of the individual color inks given to the respective hue patterns and the total ink application amounts (%) showing the total ink amounts given to the respective patterns. The ink application amount (%) is represented based on the assumption that the 100%-ink application amount means a status in which all grids of 1200 dpi have thereon one dots, respectively.

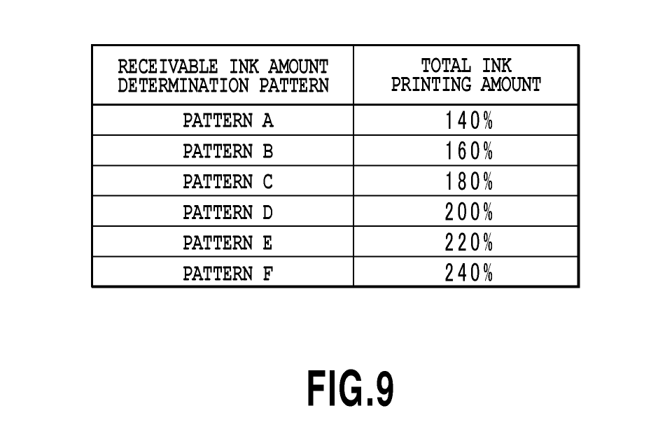

As shown in FIG. 9, the above-described six patterns A, B, C, D, E, and F have different total printing ink amounts each of which shows the total of the ink application amounts amounts of 12 colors. The difference in the total printing ink amount allows the respective patterns A to F to have a different bleeding phenomenon.

In the flowchart shown in FIG. 6, Step S603 selects an optimal pattern from among a plurality of patterns in the receivable ink amount determination pattern printed in Step 602. The optimal pattern means a pattern that is free from a defective image and that provides the highest image density or color reproduction quality. Specifically, the optimal pattern means a pattern for which generated bleeding is within an allowable range and the maximum receivable ink amount is provided. Finally, Step S604 sets, in the RAM 203 of the main control section 200, the receivable ink amount corresponding to the selected pattern to thereby complete the processing. In the case of the printing medium used in the first embodiment, the 140%-receivable ink amount is selected as an optimal pattern and the receivable ink amount is set in the RAM 203. The operations such as the pattern selection in Step S603 and the setting of the receivable ink amount in Step S604 are performed by the user in this embodiment. Specifically, from among the receivable ink amount determination patterns printed by the printing apparatus in Step S602, an optimal pattern is visually selected by the user and the pattern is inputted to the RAM 203. Another embodiment is also possible where an optimal pattern is selected by measuring a color of the determination pattern using a color measurement device instead of being visually selected by the user.

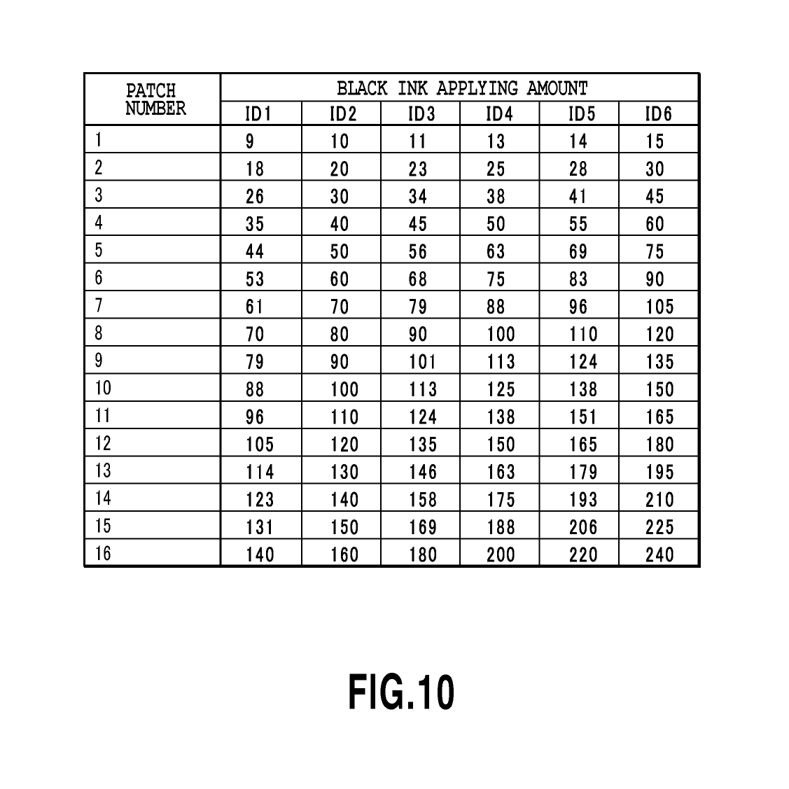

FIG. 10 is a table illustrating the ink application amounts of the respective plurality of patches included in the color calibration adjustment pattern corresponding to the receivable ink amounts set by the processing of FIG. 6. This table shows, as a typical example, the color calibration adjustment patterns ID1 to ID6 of photo black ink. In the color calibration adjustment patterns ID1 to ID6, the ink application amount corresponding to the patch number 16 corresponds to the total ink application amounts of the patterns A to F selected by the user in the processing of FIG. 6. Thus, from among the color calibration adjustment patterns ID1 to ID6, such a color calibration adjustment pattern that corresponds to the receivable ink amount set in the processing of FIG. 6 is determined as a color calibration adjustment pattern used for the color correction parameter generation processing.

In the first embodiment, the color calibration adjustment patterns ID1 to ID6 are prepared as a color calibration adjustment pattern corresponding to the 6 levels of the receivable ink amount determination patterns A to F (total ink application amounts from 140% to 240%). Each of the color calibration adjustment patterns ID1 to ID6 is composed of 16 patches from the patch 1 to the patch 16 and has a different interval between ink application amounts (unit: %). The higher the receivable ink amount is, the higher the maximum value of the ink application amount of the calibration adjustment pattern is. The reason is that an ink amount exceeding the receivable ink amount of the printing medium causes a defective image such as ink spill or bleeding. Thus, the ink amount applied in the color calibration adjustment pattern is limited to a region having an ink amount equal to or lower than the receivable ink amount to thereby improve the correction accuracy. In other words, no correction is required for a region having an ink amount exceeding the receivable ink amount. Thus, the interval between the gradation values of the patch can be reduced without printing a patch corresponding to the ink application amount higher than the receivable ink application amount. Thus, the color calibration can have an improved accuracy without increasing the number of the patches of the color calibration adjustment pattern.

For example, when the pattern A is selected as an optimal pattern, the test pattern ID1 is selected as the color calibration adjustment pattern corresponding to the 140%-receivable ink amount. Thus, when attention is paid on the ink application amounts of the patch number 1 and the patch number 2, a difference between the ink application amounts of the patch numbers is “9”. As described above, an accurate color correction can be realized by determining the interval between the ink application amounts in the color calibration adjustment pattern depending on the ink application amount corresponding to the pattern selected as an optimal pattern. The following section will describe this point more specifically.

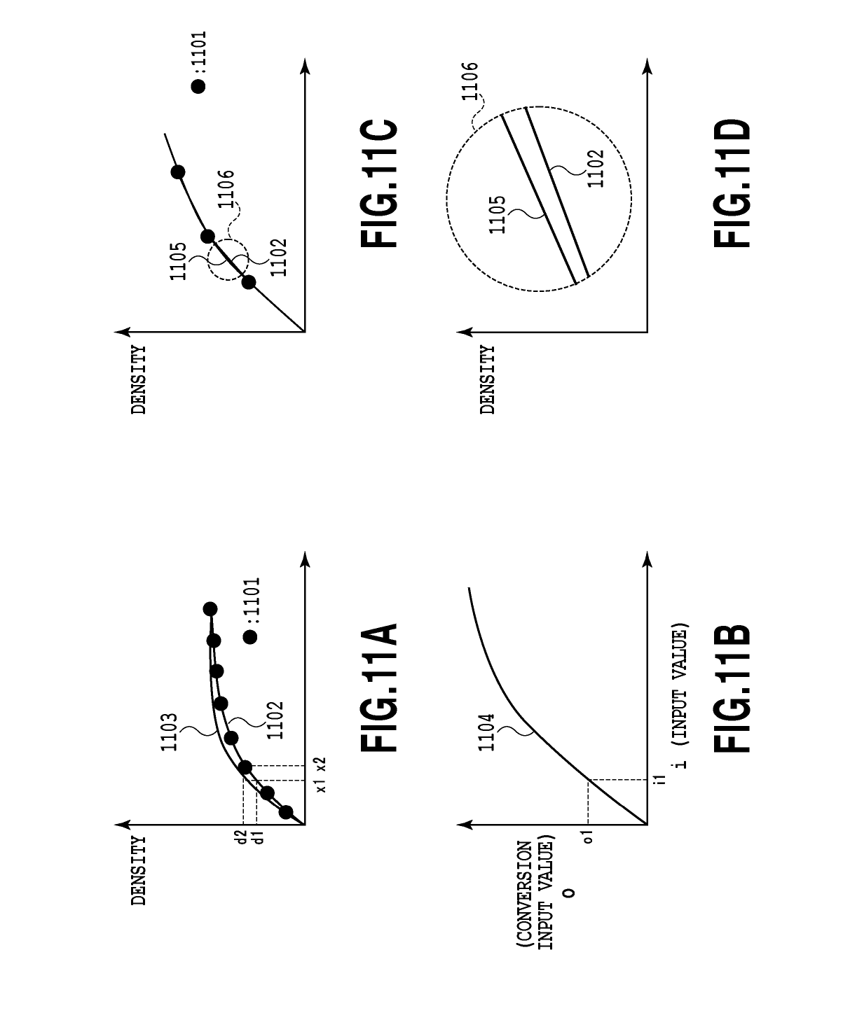

FIG. 11A is a graph illustrating the relation between the target density and the measured density. The measured density point 1101 is a density point at which the patch 406 in the determination pattern 400 printed by photo black ink is measured. The only data obtained through actual measurement is data for the measured density point. However, the expected density curve 1102 corresponding to all gradations is created by subjecting the measured density points to a linear complementation.

FIG. 11A shows that the density at the gradation value x1 of the expected density curve 1102 is d1 but the density at the target density curve 1103 is d2. Thus, in order to realize the target density d2, the gradation value x2 having the density d2 in the expected density curve 1102 may be converted as an input value. As described above, in order to realize the target density, the correction value is generated by sequentially performing the input conversion on all gradation values.

FIG. 11B is a graph illustrating the correction curve (correction table) for performing the color calibration generated based on the expected density curve. In FIG. 11B, the correction value 1104 shows the input value o1 converted in order to achieve the target density to the input value i1.

As can be seen from the method of generating the correction value as described above, an error of the expected density curve 1102 (hereinafter referred to as an expected density curve error amount) causes a lowered color correction accuracy. In order to calculate this expected density curve error amount, the present inventor calculates the target density curve by an experiment. In particular, the target density curve was set by significantly increasing the number of patches of the color calibration adjustment pattern to draw the expected density curve only based on measured density points.

FIG. 11C is a graph illustrating the relation between the target density curve and the expected density curve by a partially-enlarged gradation. The expected density curve 1102 is obtained by a linear interpolation between the density measurement points 1101. Thus, it is understood that the interpolated region 1106 deviates from the target density curve 1105.

FIG. 11D is a graph illustrating the interpolation region 1106 in FIG. 11C in an enlarged manner. In this specification, a density difference of all gradations between the expected density curve 1102 and the target density curve 1105 was defined as an expected density curve error amount. The expected density curve error amount in the first embodiment is 0.159. This expected density curve error amount of 0.159 shows a significant improvement when compared with the error amount of 0.405 as in a comparison example (which will be described later) obtained when a fixed test pattern is used regardless of the receivable ink amount of the printing medium.

As described above, in this first embodiment, a plurality of color calibration adjustment patterns for generating color correction parameters were prepared in advance. These color calibration adjustment patterns correspond to the plurality of determination patterns A to F which are used to determine the receivable ink amount of the printing medium, respectively. Then, a test pattern that corresponds to one pattern selected from among the determination patterns A to F is determined as an optimal color calibration adjustment pattern for generating a color correction parameter. The color calibration adjustment pattern thus determined is used to generate a color correction parameter. Then, the generated color correction parameter can be used to perform a color correction to thereby reduce the error amount of the expected density curve, thus realizing an accurate color density.

In this embodiment, the linear interpolation was used to calculate the expected density curve based on the measured density point. However, a spline interpolation or other interpolations also may be used. Any interpolation method can reduce, with a higher number of measured density points, the expected density curve error amount.

In this embodiment, the receivable ink amount corresponding to the selected determination pattern was set to be an ink amount of a pattern using the highest ink amount among color calibration adjustment patterns for generating a color correction parameter. However, this ink amount is not limited to one value. For example, when the receivable ink amount is 140%, the ink amount of a pattern using the highest ink amount among color calibration adjustment patterns may be 150% or 160% and may have any value close to the receivable ink amount. As an example, the ink amount of a pattern using the highest ink amount among color calibration adjustment patterns may be set to +20% of the receivable ink amount.

This embodiment has described an embodiment in which a plurality of color calibration adjustment patterns for generating a color correction parameter are prepared in advance and a table is stored in the RAM 203. This table associates a plurality of patches included in the respective patterns with the ink application amounts. However, the present invention is not limited to this.

### Second Embodiment

Next, the following section will describe the second embodiment of the present invention. The second embodiment has, as in the first embodiment, the configurations shown in FIG. 1 and FIG. 2. These configurations will not be further described. In the first embodiment, as an ink receiving characteristic of a printing medium, the receivable ink amount of the printing medium is determined. Based on the determination result, a color calibration adjustment pattern used for the processing for generating a color correction parameter can be selected. In contrast with this, in the second embodiment, an optimal color calibration adjustment pattern can be selected based on the receivable ink amount of the printing medium and the density characteristic of the printing medium as an ink receiving characteristic of a printing medium.

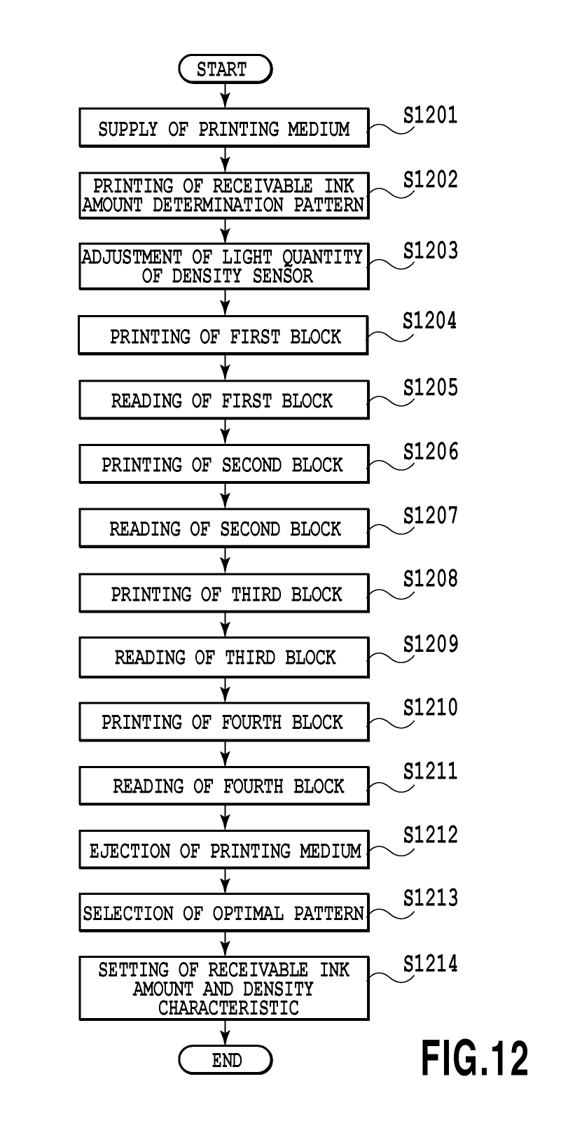

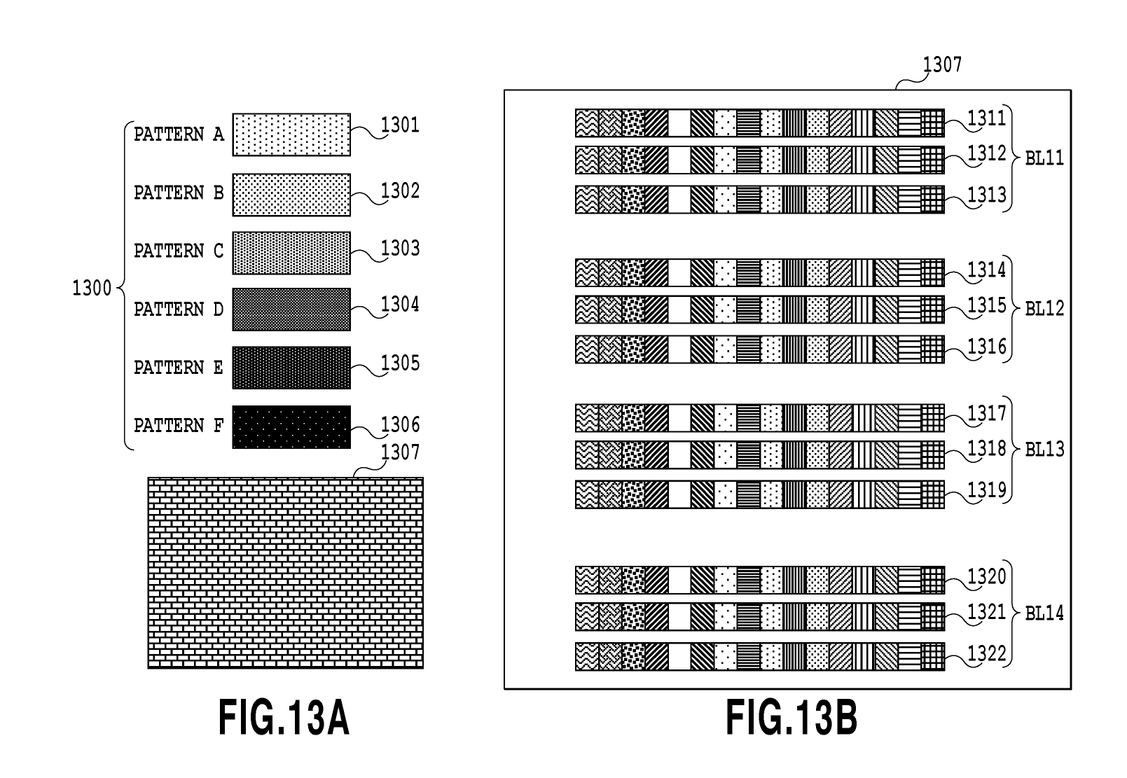

FIG. 12 is a flowchart illustrating the processing procedure for determining the receivable ink amount and the density characteristic of the printing medium. First, Step S1201 sets a printing medium in the inkjet printing apparatus. Step S1202 prints, on the printing medium, the pattern as shown in FIG. 13A to determine the receivable ink amount. In FIG. 13A, the reference numeral 1300 denotes the determination pattern in the second embodiment. This determination pattern 1300 is composed of the six patterns 1301 to 1306 and has the same configuration as that of the determination pattern 700 shown in the first embodiment.

In FIG. 13A, the reference numeral 1307 denotes the density characteristic determination pattern as one of the characteristics of the second embodiment. Step S1203 performs the light quantity adjustment on the density sensor 9 for the purpose of measuring the density characteristic determination pattern 1307. Then, Step S1204 prints the first block of the color calibration adjustment pattern 1307.

FIG. 13B illustrates the configuration of the density characteristic determination pattern 1307. The first block BL11 is composed of the three patches of the three colors of a mat black ink patch 1311, a red ink patch 1312, and a grey ink patch 1313. Each color is composed of 16 patches of 16 gradations. Step S1205 uses the density sensor 9 to measure the density of the patch of the first block BL11 of the determination pattern 1307.

Step S1206 prints the second block BL12 of the color calibration test pattern 1307. The second block BL12 is composed of three colors of a yellow ink patch 1314, a photo grey ink patch 1315, and a photo black ink patch 1316. Each color is composed of 16 patches of 16 gradations. Step S1207 uses the density sensor 9 to measure the density of the patch of the second block BL12.

Step S1208 prints the third block BL13 of the test pattern 1307. The third block BL13 is composed of the three colors of a photo magenta ink patch 1317, a magenta ink patch 1318, and a blue ink patch 1319. Each color is composed of 16 patches of 16 gradations. Step S1209 allows the density sensor 9 to measure the third block BL13.

Step S1210 prints the fourth block BL14 of the test pattern 1307. The fourth block BL14 is composed of the three colors of a photo cyan ink patch 1320, a cyan ink patch 1321, and a green ink patch 1322. Each color is composed of 16 patches of 16 gradations. Step S1211 uses the density sensor 9 to measure the patch of the fourth block BL14.

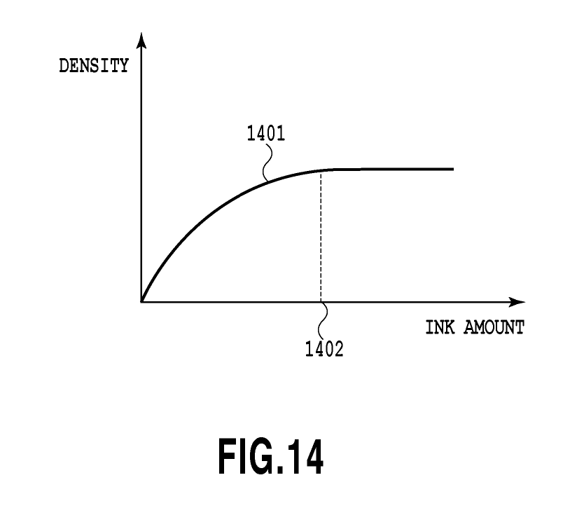

The following section will describe the density of the test pattern and the density characteristic of the printing medium thus measured. FIG. 14 is a graph illustrating the density characteristic of the printing medium. In FIG. 14, the reference numeral 1401 denotes the density value curve of the density characteristic determination pattern 1416 of photo black ink. This density value curve shows no change in the density value at a fixed number of gradations or more. This shows that the printing medium has the maximum density when the ink application amount reaches such an application amount that causes ink to penetrate and to be fixed in the entire receiving layer of the printing medium. Specifically, no change is caused in the density on the printing medium because ink is merely given in an application amount at which ink penetrates and is fixed in the entire receiving layer and ink is layered on an upper layer of the fixed ink.

In the second embodiment, the density characteristic of the printing medium is defined as an ink application amount at which a change amount of the density on the printing medium between gradations adjacent to each other is equal to or lower than a predetermined threshold value (or equal to or lower than the value O.D of 0.01). The ink amount 1402 in FIG. 14 shows the density characteristic of the printing medium. In the second embodiment, the same printing medium as that of the first embodiment is used. The density characteristic was determined to be 128%. The second embodiment also can use a configuration in which a color measurement device that can obtain a coloring value for example is used to obtain a CMYK value, a L*a*b*value, an XYZ value, or an RGB value of the pattern.

In FIG. 12, Step S1212 ejects the printing medium for which the printing and reading of the test pattern are completed. Step S1213 selects an optimal pattern from among the receivable ink amount determination patterns A to F (1301 to 1306) printed in Step S1202. The printing medium used in the second embodiment is the same printing medium as that of the first embodiment. The pattern A was selected as an optimal pattern. Specifically, the printing medium was determined to have a 140%-receivable ink amount. Finally, Step S1214 sets, in the RAM 203 of the main control section 200, the receivable ink amount corresponding to the pattern selected in Step S1213 and the density characteristic obtained in Steps S1204 to S1211, thereby completing the processing.

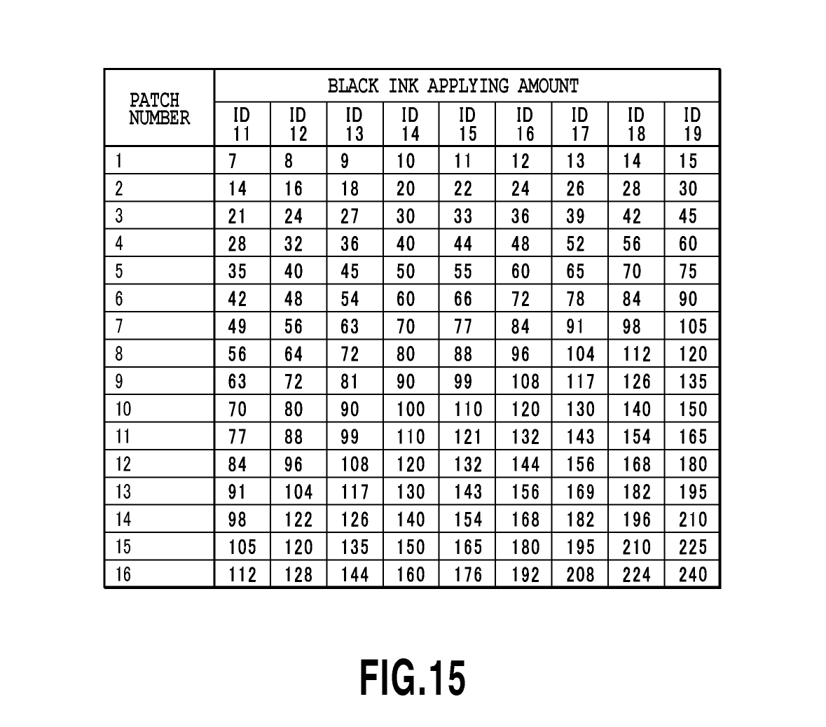

FIG. 15 is a table illustrating the ink application amounts of the respective gradations in the respective test patterns corresponding to the receivable ink amount and the density characteristic of the printing medium. As an example, the test pattern of photo black ink is shown. The test patterns ID11 to ID19 are prepared to correspond to the ink amount of 9 levels from 112% to 240%. The respective levels of ink amounts are selected by comparing the receivable ink amount with the density characteristic (the ink application amount at which a change amount of the density on the printing medium between gradations adjacent to each other is equal to or lower than the threshold value (the value O.D equal to or lower than 0.01)) to select a smaller ink amount. For example, the printing medium having a 140%-receivable ink amount and a 128%-density characteristic has a 128%-ink amount.

A proportional relation is established between the ink amount thus determined and the gradation number 16 as the maximum value of the ink application amount of each test pattern. Thus, the higher the determined ink amount is, the higher the maximum value of the ink application amount of each test pattern is. The reason is that the correction accuracy is improved by limiting the output of the test pattern to a region showing a change in the density characteristic to generate the correction value. In other words, a density value can be accurately generated for a region showing no change of the density characteristic without printing a test pattern.

In the second embodiment, the test pattern ID12 corresponding to the 128% ink amount is selected. Thus, when attention is paid on the ink application amounts of the patch number 1 and the patch number 2, a difference in the ink amount between both of the gradations is “8”, which is smaller than the difference of “9” in the first embodiment. As described above, by reducing the interval between the ink application amounts in the test pattern, the expected density curve error described in the first embodiment can be further reduced.

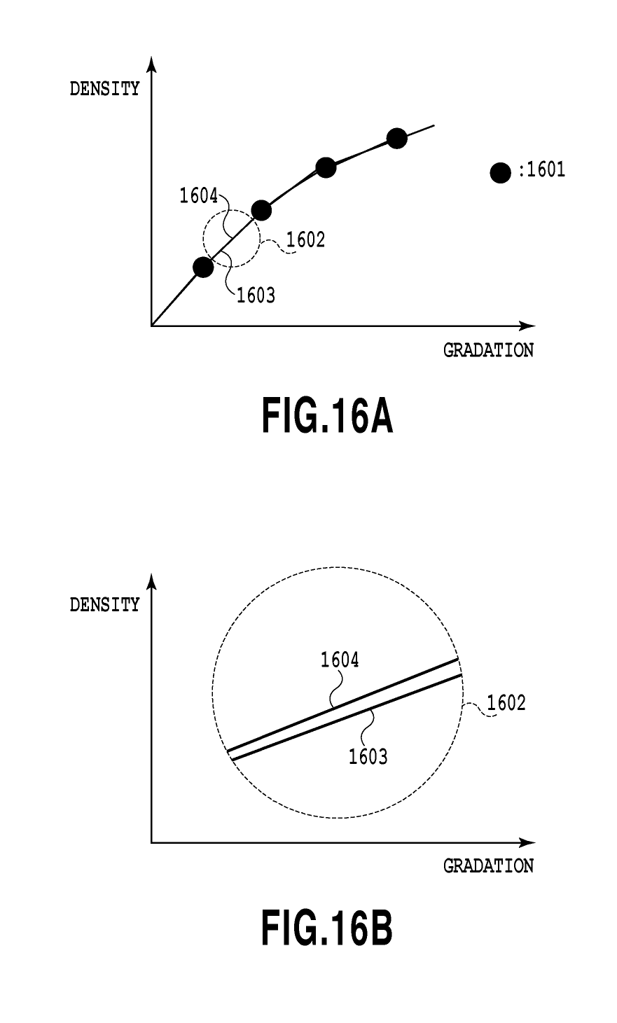

FIG. 16A is a graph illustrating the relation between the target density curve 1604 and the expected density curve 1603 by a partially-enlarged gradation. The expected density curve can be obtained by a linear interpolation between the density measurement points 1601. Thus, there is a possibility where the interpolated region 1602 deviates from the target density curve. This status is shown in FIG. 16B. FIG. 16B is a graph illustrating the interpolation region 1602 in FIG. 16A in an enlarged manner. In the second embodiment, the expected density curve error amount between the expected density curve 1603 and the target density curve 1604 is 0.098, thus showing a further-reduced expected density curve error amount from the case of the first embodiment.

As described above, in the second embodiment, the receivable ink amount and the density characteristic of the printing medium are considered and an optimal test pattern as color calibration adjusting pattern is selected from among a plurality of test patterns prepared in advance for generating a color correction parameter. As a result, the expected density curve error amount can be reduced for the execution of the color correction processing, thus providing a more accurate color correction.

In the first and second embodiments, only black ink among ink colors constituting a test pattern was described in detail. However, the same processing based on the same procedure can be performed on the other ink colors to provide the same effect.

### Other Embodiments

In the above respective embodiments, a case exemplarily was described in which each color calibration adjustment pattern had the total of 16 gradations. However, the total of gradations also may be any number other than 16. Any number of gradations can improve the accuracy of the color correction by limiting the printing of the color calibration adjustment pattern to a region equal to or lower than the receivable ink amount of the printing medium or showing a change in the density to print a color calibration adjustment pattern so that a corrected input value is generated based on the reading value. Furthermore, although the above respective embodiments have used an equal interval between gradations adjacent to each other for all gradation, a different interval depending on a gradation region also may be used.

An ink amount used for a color calibration adjustment pattern for colors other than black is not limited to the amount of black ink and can be changed depending on an ink color. For example, when inks have the same hue and different densities, a color calibration adjustment pattern may be changed by a light ink having a low density and a dark ink having a high density. Specifically, a difference in the ink application amount between gradations adjacent to each other in a low gradation-side test pattern is increased for the light ink and is reduced for the dark ink.

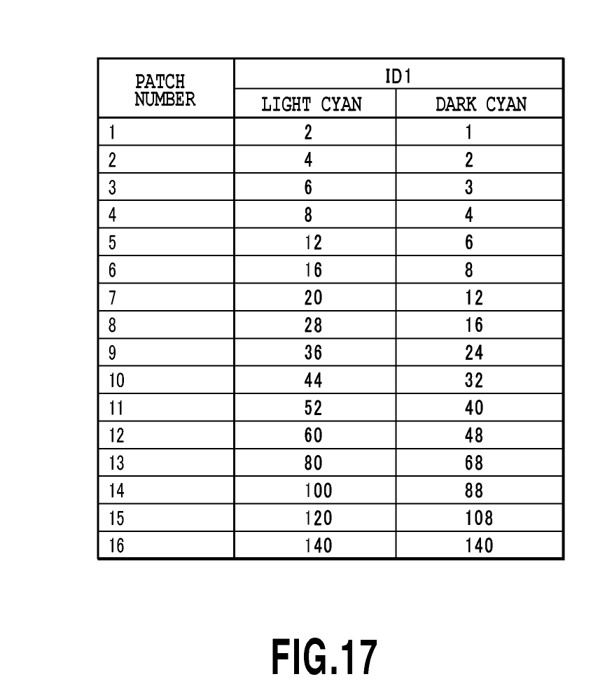

FIG. 17 illustrates an example in which the color calibration adjustment pattern is changed depending on deep or light ink as described above. In FIG. 17, the ink amount of the gradation 16 is the maximum ink amount in the test pattern. Each ink has a 140% ink amount. When the low gradation side is defined as the gradation up to the ink application amount of 12% for example, the number of gradations at the low gradation side in the test pattern of light cyan ink having a low density is 5. On the other hand, the number of gradations at the low gradation side in the test pattern of deep cyan ink having a high density is 7. The reason is that dark ink shows a larger change in the printing density at the low gradation side than in the case of light ink and thus a more minute correction is advantageous.

Since the printing density characteristic is different depending on the type of the printing medium, such a configuration is desired in which the color calibration adjustment pattern is determined for each type of the printing medium.

In the first embodiment, the receivable ink amount was determined as an ink receiving characteristic of a printing medium. In the second embodiment, the receivable ink amount and the density characteristic were determined as an ink receiving characteristic of a printing medium. However, the present invention is not limited to this. Another configuration is possible where only the density characteristic is determined and a calibration adjustment pattern is selected based on the determination result.

### Comparison Example

The following section will describe, as a comparison example to be compared with the embodiment, a case in which a fixed test pattern was used regardless of the receivable ink amount of the printing medium. As in the first embodiment, the comparison example sets the receivable ink amount based on the flowchart shown in FIG. 6. The comparison example uses the same printing medium as that of the first embodiment, thus resulting in the 140% receivable ink amount.

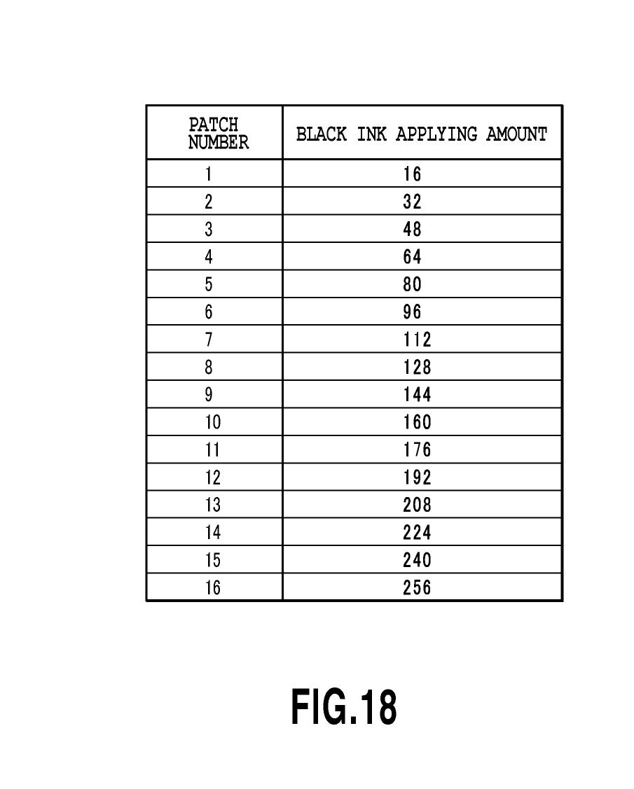

FIG. 18 is a table illustrating the ink application amounts of the respective gradations in a color calibration adjustment pattern used for the color correction parameter generation processing in this comparison example. This table shows the test pattern of photo black ink as a typical example. In this comparison example, a test pattern (see FIG. 18) is used for which all printing media has the maximum ink application amount value of 256% in the flowchart of FIG. 6 regardless of the receivable ink amount of the determined printing medium.

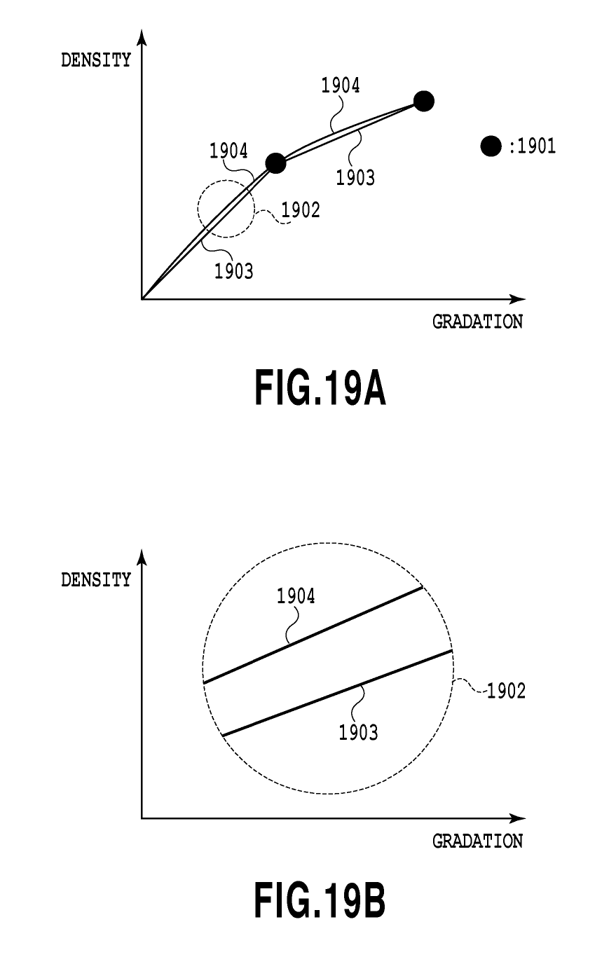

FIG. 19A is a graph illustrating the relation between the target density curve and the expected density curve in this comparison example by a partially-enlarged gradation. This comparison example also can obtain the expected density curve 1903 by a linear interpolation between the density measurement points 1901. However, the expected density curve 1903 in the interpolation region 1902 significantly deviates from the target density curve 1904.

FIG. 19B is a graph illustrating the interpolation region 1902 in FIG. 19A in an enlarged manner. The expected density curve error amount between the expected density curve 1903 and the target density curve 1904 is 0.405. As described above, the expected density curve error amounts in the first and second embodiments are 159 and 0.098, respectively. Thus, this comparison example cannot realize an accurate color correction as in the above respective embodiment.

The present invention can be applied to all machines using printing media such as paper, cloth, leather, non-woven cloth, an OHP paper and metal. Specifically, the invention can be applied to machines including a business machine such as a printer, a copier, or a facsimile or an industrial production machine. The present invention is particularly useful for a machine for printing a large printing medium at a high speed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-018358, filed Jan. 31, 2012, which is hereby incorporated by reference herein in its entirety.

What is claimed is:

1. An image processing method, comprising:
an obtaining step of acquiring information regarding an ink amount that can be applied to a unit area of a printing medium; and
a determination step of determining, based on the information obtained in the obtaining step, a combination of a plurality of ink application amounts corresponding to a plurality of first patches for adjusting ink application amounts corresponding to the respective gradation levels of an image to be printed on the printing medium.

2. The image processing method according to claim 1, wherein: the number of the plurality of first patches corresponding to the combination determined in the determination step when the ink amount shown by the information is a first amount is equal to the number of the first patches corresponding to the combination determined in the determination step when the ink amount shown by the information is a second amount higher than the first amount, and a difference among the plurality of ink application amounts included in the combination determined in the determination step when the ink amount shown by the information is the first amount is smaller than a difference among the plurality of ink application amounts included in the combination determined in the determination step when the ink amount shown by the information is the second amount.

3. The image processing method according to claim 1, further comprising:
a second obtaining step of acquiring a measurement result obtained by measuring the plurality of first patches corresponding to the combination determined in the determination step; and
a correction step of correcting the image data of the image based on the measurement result obtained in the second obtaining step.

4. The image processing method according to claim 3, further comprising:
a printing step of printing, based on the image data corrected in the correction step, the image to a printing medium of the same type as the type of the printing medium on which the plurality of first patches are printed.

5. The image processing method according to claim 1, wherein: a difference among the plurality of ink application amounts included in the combination determined in the determination step is substantially equal.

6. The image processing method according to claim 1, wherein: the determination step includes a selection step of selecting, based on the information, one combination from the plurality of combinations stored in a storage unit.

7. The image processing method according to claim 1, wherein:
the obtaining step further includes a printing step of printing, to the unit region of the printing medium of the same type as the type of the printing medium, a plurality of second patches for determining a receivable ink amount to which mutually-different amounts of ink are applied, and
the information is information corresponding to an ink application amount applied to the unit region of any of patch among the second patches printed in the printing step.

8. The image processing method according to claim 7, wherein:
the obtaining step further includes a measurement step of measuring the second patches printed in the printing step by a measurement unit and, based on the result of measuring the second patches by the measurement unit, information regarding the ink amount applied to the unit area of any one of second patches is obtained as the information.

9. An image processing apparatus, comprising:
an obtaining unit configured to acquire information regarding an ink amount that can be applied to a unit area of a printing medium; and
a determination unit configured to determine, based on the information obtained in the obtaining step, a combination of a plurality of ink application amounts corresponding to a plurality of first patches for adjusting ink application amounts corresponding to the respective gradation levels of an image to be printed on the printing medium.

10. The image processing apparatus according to claim 9, wherein: the number of the plurality of first patches corresponding to the combination determined in the determination step when the ink amount shown by the information is a first amount is equal to the number of the first patches corresponding to the combination determined in the determination unit when the ink amount shown by the information is a second amount higher than the first amount, and a difference among the plurality of ink application amounts included in the combination determined in the determination unit when the ink amount shown by the information is the first amount is smaller than a difference among the plurality of ink application amounts included in the combination determined in the determination unit when the ink amount shown by the information is the second amount.

11. The image processing apparatus according to claim 9, further comprising:
a second obtaining unit configured to acquire a measurement result obtained by measuring the plurality of first patches corresponding to the combination determined by the determination step; and
a correction unit configured to correct the image data of the image based on the measurement result obtained by the second obtaining unit.

12. The image processing apparatus according to claim 11, further comprising:
a printing unit configured to print, based on the image data corrected by the correction unit, the image to a printing medium of the same type as the type of the printing medium on which the plurality of first patches are printed.

13. The image processing apparatus according to claim 9, wherein: a difference among the plurality of ink application amounts included in the combination determined by the determination unit is substantially equal.

14. The image processing apparatus according to claim 9, wherein: the determination unit includes a selection unit of selecting, based on the information, one combination from the plurality of combinations stored in a storage unit.

15. The image processing apparatus according to claim 9, wherein:
the obtaining unit further includes a printing unit of printing, to the unit region of the printing medium of the same type as the type of the printing medium, a plurality of second patches for determining a receivable ink amount to which mutually-different amounts of ink are applied, and
the information is information corresponding to an ink application amount applied to the unit region of any of patch among the second patches printed by the printing unit.

16. The image processing apparatus according to claim 15, wherein:
the obtaining unit further includes a measurement unit configured to measure the second patches printed by the printing unit by a measurement unit and, based on the result of measuring the second patches by the measurement unit, information regarding the ink amount applied to the unit area of any one of second patches is obtained as the information.
